(19) United States
(12) Patent Application Publication
(10) Pub. No.: US 2005/0009972 A1
(43) Pub. Date: Jan. 13, 2005

(54) Permaflex

(75) Inventors: James T. Rauh, Akron, OH (US); Joseph Rauh, Akron, OH (US)

Correspondence Address: BROUSE McDOWELL, Suite #500, 106 S. Main Street, Akron, OH, 44308-1471, US

(73) Assignee: ENGINEERED PLASTICS CORPORATION

(21) Appl. No.: 10/840,168

(22) Filed: May 6, 2004

Related U.S. Application Data
(60) Provisional application No. 60/468,407, filed on May 6, 2003.

(51) Int. Cl. C08K 5/09

(52) U.S. Cl. 524/284

(57) ABSTRACT

A new and improved method for producing copolymer thermoplastic elastomer esters is described herein.

### BACKGROUND OF THE INVENTION

A. Field of the Invention

This application claims priority to provisional patent application Ser. No. 60/468,407, entitled Permaflex, filed May 6, 2003.

The present invention provides a new and improved versatile, permanent, flexible plastic, and overcomes certain difficulties inherent in the related inventions while providing better overall results.

### SUMMARY OF THE INVENTION

In accordance with one aspect of the present invention, a twin screw reaction process utilizes high speed, temperature control, and sheer.

Still other benefits and advantages of the invention will become apparent to those skilled in the art upon a reading and understanding of the following detailed specification.

Having thus described the invention, it is now claimed:

### PermaFlex Provisional Patent Application

Motivation and Creation:

Engineered Plastics Corporation desired to compete with thermoplastic polyester elastomers such as Arnitel (DSM), and Hytrell (Dupont). Their materials are made in reactors from monomers and polymerized to produce these polymers of hard and soft segments; polyester being the hard segment, and polyether being the soft segment.

This process is expensive to set up, dangerous to operate, and restrictive in its use, making it necessary for secondary operations, such as compounding to color, stabilize, modify, and fill. This co-monomer reaction process also limits the range of mole weights, hardness and polymers available in the initial reactor process.

Engineered Plastics Corporation wished to manufacture less expensive, higher quality thermoplastic polyester elastomers (TPE's). We have requests from potential customers for these TPE's for manufacture of tubing and hoses and other products.

Engineered Plastics Corporation combined polymers and polyesters of hard and soft nature (TPU being the soft (Exhibits E, F), and rigid polyesters PBT, PC, PET, PETG, PCT, PCTG, SA, and MUX G being the hard (Exhibits D, G-M), with plastisizers, antioxidants, UV stabilizers, release agents, and colors. With twin screw extruder processing, we were able to produce TPE's of a wide variety and a broad range of physical properties, in one step, with less capital expense, lower material costs, greater flexibility and safety, and with lower environmental impact.

Engineered Plastics Corporation's twin screw reaction process utilizes high speed, temperature control, and sheer. This is dependant on the screw length, RPM, and screw segment configuration, yielding greater efficiency. Engineered Plastics Corporation has produced these TPE's, and we have had these products then converted into finished goods experimentally.

Engineered Plastics Corporation's process success was dependent on thousands of experiments. This process, and combinations of materials, yields products far surpassing anything on the market today in performance, price and efficiency. (Exhibit N)

Synthesis:

The synthesis of new copolymer thermoplastic elastomer esters by alloying polyester plastics with thermoplastic urethane elastomers is as follows. Novel thermoplastic polyester elastomers (TPE's) are synthesized that exhibit useful properties such as elastomeric deformation and reformation of shape under stress and relaxation, considerable elongation, high tensile, temperature resistance, compression set resistance, chemical resistance and general over-all durability.

Polyesters such as PBT, PC, PET, PETG, PCT, PCTG, SA, and MUX G, (hereby referred to as PEM) and thermoplastic polyurethane (TPU) were combined in a twin screw extruder to achieve dispersions in various ratios from 90/10 to 50/50 reciprocally on PEM to TPU. Antioxidants, third polymer modifiers, lubricants, and release agents were also added to modify physical properties, but the foundation of these compounds is PEM and TPU.

The results of these alloyed blends show solubility, miscibility and the creation of a new material. The digital scanning calorimeter (DSC) results (exhibit A) show different peaks or curves than the PEM or TPU individually (exhibit B&C). Also, the physical properties of the alloy show properties that are not found in any of the ingredients. The elongation of the (alloy) TPE 55, 50/50 bend of PEM & TPU show 800% elongation, yet the PEM=300% elongation (exhibit D) and the TPU=500% elongation (exhibit E), yet the alloy retains 7000 PSI tensile. Another alloy, TPE 35, 80% TPU (500% elongation) & 20% PEM (300% elongation), yield over 1100% elongation and 6000+tensile. (The specimen did not break; 1100% is the limit of our testing machine.)

These alloys also show great stability in temperature extremes:
TPE=No break notched izod resistance @−40° F., 73° F. and 300° F.
TPE=No change in tensile and elongation @−40° F., 73° F. and 300° F.
PEM=brittle @−40° F.
TPU=3 izod @−20° F., melts @300° F.
TPE has resistance to hydrolysis 210° F., TPU is unsuitable

The new alloy exhibits compression set resistance equal to thermoset rubbers, a wide range of hardness (depending on formulation) from 40 A to 80 D, and a wide range of flex modulus from rubbery to stiff.

The new alloy shows flexibility, thermoplastic processing, reusability, super durability and stability. Our initial results show resistance to chemical & UV attack.

The following graphs show the results, which further demonstrate the synthesis of the new polymer. (Exhibits O-U)

### Permaflex TPE Property Guide

PermaFlex is the versatile, permanent, flexible plastic. Its flexibility, stability, toughness, strength and elasticity give PermaFlex millions of applications. The stability of PermaFlex allows its use in all types of demanding environments. It has tremendous resistance to attack by chemicals, solvents, weather, vapors, gases, microbes, and UV light.

PermaFlex is temperature stable with retention of all physical properties, including no-break izod and no-break dart impact, at temperatures from −40° to 300° F., and some at up to 375° F.

The creep resistance of PermaFlex is equal to or exceeds many thermoset rubbers with as little as 10% compression set @100° C. for 72 hours.

The electrical resistance of PermaFlex makes it a perfect insulator, yet it can be modified to be anti-static or conductive.

PermaFlex is tougher than rubber or other plastics, and is resistant to abrasions, scratches, cuts and tears.

The flex and elasticity of all grades of PermaFlex makes it's durability outstanding. The flex modulus of the product range from rubbery to rigid or 2,000 to 300,000 PSI for unfilled products. All grades are flexible for millions of cycles and are still testing after 1000's of hours.

PermaFlex elasticity and tensile modulus are unrivaled. It has up to 8000 PSI tensile and over 1600% elongation with tensile modulus of 5000+from 100% elongation to 1000% elongation. PermaFlex ranges in durometer from 35 to 75 D at this time, but softer and harder versions are coming.

PermaFlex is made with all FDA approved ingredients.

PermaFlex is easily processed by injection molding, extrusion, blow molding, or thermoforming. (See process guide.)

Uses include film, fibers, adhesives, packaging, and modifiers for plastic, asphalt, tar and oil. Also for transportation, appliances, house wares, construction, safety, agricultural and farming, apparel, toys, lawn and garden, military, medical, furniture, marine, sporting goods, tools, utilities, communications, textiles and industrial.

Uses:

Optical media—For example, CD, DVD, CDR, CDRW, minidisk, VCD, all other forms of digital optical media. Eyewear—Glasses, lenses, sunglasses, safety glasses, screens.

Transportation—Interiors, instrument panels, bolsters, bezels, boxes, covers, holders, knobs, pedals, rests, ducts, lenses, glazing, and trim. Exterior—hubcaps, body parts, bumpers, panels, doors, hoods, fenders, lights, and trim.

Appliances—Housings, panels, displays, bins, trays, covers, boards, bases, bezels, fans, coffee makers, computer housing.

Electronics—Housings, covers, displays, bezels, boxes, storage, memory, optics, trays, keyboards, mice, conductors, insulators, diodes, capacitors, cords, wiring.

House wares—Cutlery, handles, boards, boxes, glasses, dishes, utensils, bins, aquariums, terrariums, bowls, pitchers.

Construction—Coatings, paints, films, tanks, plumbing fixtures, sinks, glazing, cabinets, doors, flooring, bathrooms, fixtures, showers, roofing gutters, siding, decking, lighting, skylights, atriums, booths, blocks, structural supports, facades, cladding, signs, trim, shelving, racking, piping, pipe, tubes, junction boxes, connectors, insulators, insulation, foams.

Safety—Glasses, shields, apparel, padding, helmets, barricades, lenses, lights, bumpers, delineators, braces, signs, reflectors, cones, helmets, barrels.

Agricultural and farming—Housings, trays, films, greenhouse, pots, seed trays, tools, blades, silos, grain storage, storage vessels, tanks, dairy tanks, troughs, cow feeders, pens, dividers, enclosures.

Apparel—Buttons, bangles, beads, bands, belting, boots, jewelry, rings, shoes, sandals, straps, belts, fibers, flocking, insulation, rod, sheet, tube, bullet proof vests, face shield, visors, eyewear, goggles, orthopedics, prosthetics, diapers, hair clips, hats, fake nails, dental, helmets, pads.

Toys—Balls, guns, dolls, cars, blocks, games, pieces, dice, cubes, flying disks, rattles, trains, trucks, planes, models, riding toys, bicycles, baby seats, car seats, basketball backboards, action toys, swings, seats, sliding boards, playgrounds, toy housing, toy animals, pet toys, figurines, toy boats, floats, pools, tanks, padding, displays, doll houses, boards.

Lawn and garden—Rakes, shovels, chairs, trowels, tillers, blades, lawn mowers, housings, weed whackers, hoses, sprinklers, tables, furniture, decking, enclosures, light holders, picnic tables, umbrellas.

Military—Shielding, firearms, housings, vessels, helmets, boots, apparel, armor, displays, shelters, canopies, aircraft, bullets, skins, sonar coverings, cables.

Medical—Tubing, catheters, valves, prosthetics, needles, syringes, pans, packaging, piping, pumps, displays, implants, casts, machines.

Furniture—Tables, chairs, counters, stands, planters, lantems, stools, desks, lamps, lighting, chandeliers, couches, ladders, stairs, vases.

Marine—Boats, canoes, kayaks, hulls, skins, seats, supports, steering wheels, dash boards, windows, buoys, bumpers, rope, netting, patches, hatches, oars, dinghies, motor housings, displays, housing, sails, hooks, pulleys, galleys, heads, paneling, interior, flooring, wall covering, mast, cleats.

Sporting goods—Fishing lures, backboards, billiard balls, pool tables, ping pong tables, rackets, paddles, balls, strings, pools, bows, guns, tents, poles, chairs, cleats, skis, hockey pucks, ski goggles, poles, skates, boats, rollers, wheels, roller blades, scooters, pads, helmets, posts, rims, netting, bowling balls and pins, shafts, golf clubs, golf ball cover, tees, golf carts, golf bags, fins, goggles, snorkels, hockey sticks, fishing poles, horseshoes, vaulting poles.

Packaging—Bottles, trays, films, boxes, foams, cans, jars, dispensers, toilet paper and paper towel dispensers, lids.

Tools—Handles, flashlights, lighting, optics, mallets, power tools, housings, tables, hoses.

Utilities—Solar panels, windmill blades, wave baffles, turbine blades, hydraulic blades, impellor parts, batteries, housings, light piping, lenses, solar lenses, solar laser, giant lenses.

Communications—Telephones, fiber optics, digital media, credit cards, smart cards, cd cards, phone cards, business cards, pens, speakers, faxes, mail boxes, wires, cell phones, cables, wire, relays, piping, conduits, satellite dishes.

Textiles—Woven and unwoven fiber, reflective, illuminated, luminous, spun, and drawn.

Industrial—Hoses, tubes, seals, belts, gears, wheels, casters, rollers, tires, hoses, tubes, adhesives both hot melts and solvent based.

1. A method for producing copolymer thermoplastic elastomer esters, the method comprising the steps of:
combining polyester and thermoplastic polyurethane in a twin screw extruder to achieve dispersions in ratios from 90:10 to 50:50; and,
adding antioxidants, polymer modifiers, lubricants, and release agents to modify physical properties.
